(19) United States
(12) Patent Application Publication
(10) Pub. No.: US 2009/0107572 A1
(43) Pub. Date: Apr. 30, 2009

(54) HIGHLY ABRASION-RESISTANT IONOMER PIPES

(75) Inventors: Richard Allen Hayes, Beaumont, TX (US); Mark B. Kelly, Beaumont, TX (US); Ward Metzler, Burlington (CA)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/262,883

(22) Filed: Oct. 31, 2008

Related U.S. Application Data
(60) Provisional application No. 60/984,153, filed on Oct. 31, 2007.

(51) Int. Cl. F16L 9/14; F16L 9/147; B29C 63/26

(52) U.S. Cl. 138/141; 156/282; 156/294; 138/146; 428/36.91

(57) ABSTRACT

A pipe or tube article is disclosed that comprises an innermost layer wherein the innermost layer has a thickness of about 6.3 to about 102 mm and comprises an ionomer composition prepared from an acid polymer comprising an α-olefin having 2 to 10 carbons and about 5 to about 25 weight % based on the total weight of the acid polymer of an α,β-ethylenically unsaturated carboxylic acid having 3 to 8 carbons; and about 5 to about 90% of the carboxylic acids are neutralized with a metal ion to provide long lifetime, highly abrasion-resistant pipes for mining and other transportation uses. Methods for preparing the article and transporting abrasive materials through the article are also described.

This application claims priority to U.S. provisional application, Ser. No. 60/984153, filed Oct. 31, 2007, the entire disclosure of which is incorporated herein by reference.

The invention relates to highly abrasion-resistant tubular articles (pipes) comprising ionomer layers that provide for the transport of particulates and slurries, methods and compositions to produce the articles, and methods of transporting abrasive materials through them.

### BACKGROUND OF THE INVENTION

Mining operations require the transport of highly abrasive particulate or slurry streams. The recovery of bitumen from oil sands is becoming increasingly important within the energy industry. Processing oil sand includes transporting and conditioning the oil sand as an aqueous slurry over kilometer lengths of pipe up to 1 meter in diameter. Processes for recovery of bitumen from oil sands are known (U.S. Pat. Nos. 4,255,433, 4,414,117, 4,512,956, 4,533,459, 5,039,227, 6,007,708, 6,096,192, 6,110,359, 6,277,269, 6,391,190, US2006/0016760, US2006/0249431, US2007/0023323, US2007/0025896, WO2006/060917, CA1251146, CA2195604, CA2227667, CA2420034, CA2445645, and CA2520943). Use of caustic to assist in the recovery process of oil from oil sands is also known (US2006/0016760 and US2006/0249431). Other mining operations that include the transport of highly abrasive particulate or slurry streams from the mine to processing refinery include, for example, iron ore, coal and coal dust, and the like, and in further non-mining transport processes, such as grain, sugar and the like.

Often, metal pipes, such as carbon steel or cast iron pipes, are used for the transport of these highly abrasive streams. They are expensive, heavy and only provide a temporary solution since they are eventually destroyed. To increase their lifetimes, the metal pipes may be rotated 90 degrees on their axes on a regular basis to provide a new transport surface. However, because of the pipe weight, this rotation is difficult and ultimately the entire pipe is worn out and must be replaced.

Use of plastic pipes, pipe liners and pipe coatings has been proposed to reduce these shortcomings. Material selection is critical. Many of the commonly available materials cannot stand up to such highly-abrasive mining streams and are quickly worn out. For example, high density poly(ethylene) pipes are generally used as liners for sanitary sewer and wastewater pipelines but they rapidly degrade under highly abrasive environments. U.S. Pat. No. 4,042,559 discloses abrasive granule-filled, partially-cured coatings for use in abrasion resistant coated pipes for the transport of mining slurries. U.S. Pat. No. 4,254,165 discloses processes to produce abrasion resistant pipes with 0.04-0.05-inch thick coatings of filled (such as sand) polyolefins, such as low and medium density poly(ethylene) and including poly(ethylene-co-acrylic acid). U.S. Pat. No. 4,339,506, WO90/10032, and CA1232553 disclose rubber liners for pipes. U.S. Pat. No. 4,215,178 discloses fluoropolymer-modified rubber pipe liners. US2006/0137757 and US2007/0141285 disclose fluoropolymer pipe liners. Polyurethane pipe coatings are known (U.S. Pat. No. 3,862,921; U.S. Pat. No. 4,025,670, US2005/0194718, US2008/0174110, GB2028461, JP02189379, JP03155937, and JP60197770). US2005/0189028 discloses metal pipe coated with a polyurethane liner to transport tar sand slurry. GB2028461 discloses an abrasion-resistant pipe lining comprising a urethane rubber thermoset embedded with the particles of the material to be transported (coal dust, grain or sugar) through transport of the materials during curing. Abrasion resistant pipes with elastomeric polyurea coatings are disclosed in U.S. Pat. No. 6,737,134. A shortcoming of the polyurethane coatings includes the highly complex processes for applying the coating to the metal pipe.

Use of ionomer compositions made from acid copolymer compositions comprising an α-olefin monomer and an α,β-ethylenically unsaturated carboxylic acid monomer as pipes, pipe liners and pipe coatings is known. For example, JP2000179752, JP2000352480, JP2000352479, JP2002249750 disclose 1.5 mm (0.05 inch) thick ionomer tubes for use as an anticorrosive lining for metal pipes designed for water service, wastewater and the like. JP08011230 and JP08259704 disclose heat-shrinkable, crosslinked ionomer tubes for the protection of pipes and cables. EP0586877 discloses heat-shrinkable, crosslinked ionomer tubes with wall thicknesses of 1.5 mm. JP3700192 discloses heat-shrinkable, foamed ionomer tubes. JP2000179752 discloses the use of epoxy primers to adhere ionomer tubes to water service metal pipes.

US2006/0154011 and JP63051135 disclose poly(ethylene) blend pipes with a minor ionomer component. JP2000034415 discloses glass reinforced nylon pipes that include a minor ionomer component. Multilayer coextruded pipes with ionomer layers are known (EP209396; JP2004114389;JP2004098515;JP2001041360;JP59131447; and JP59131448). JP3711305 discloses tubes made from ionomer compositions filled with 10-50 wt % inorganic fine-grain particles for use in lithium secondary batteries.

U.S. Pat. No. 3,429,954, U.S. Pat. No. 3,534,465, US2006/0108016, JP2002248707, JP2002254493,JP2002257264,JP2002257265,JP2002327867, and US2005/0217747 disclose the use of poly(ethylene-co-(meth)acrylic acid) copolymers as adhesive layers to attach poly(ethylene) pipe liners to pipes. JP2002248707, JP2002254493, JP2002257264, JP2002257265, JP2002327867, JP2003294174, and US2005/0257848 disclose ionomers as adhesive layers to attach poly(olefin) pipe liners to steel pipes.

Metal articles coated with ionomers are known (U.S. Pat. Nos. 3,826,628, 4,049,904, 4,092,452, 4,371,583, 4,438,162, 5,496,652, US2006/0233955; and WO00/10737). Ionomer powder coating compositions are known (U.S. Pat. Nos. 3,959,539, 5,344,883, 6,132,883, 6,284,311, 6,544,596 and 6,680,082). WO00/27892 discloses scratch and abrasion resistant ionomers neutralized with at least 2 metal ions for protective formulations. Acid copolymer powder coating compositions are known (U.S. Pat. No. 4,237,037 and U.S. Pat. No. 5,981,086). Metal articles powder coated with ionomers are known (U.S. Pat. Nos. 3,991,235, 4,910,046, 5,036,134, 5,155,162, and 6,284,311). Metal powder coatings comprising anhydride-grafted polyolefins are disclosed in U.S. Pat. No. 4,048,355. Metal powder coatings comprising acid copolymers are disclosed in U.S. Pat. No. 4,237,037. Corrosion-resistant zinc metal-filled ionomer metal coatings are disclosed in U.S. Pat. No. 5,562,989. Corrosion-resistant zinc metal-filled acid-grafted polyolefin metal coatings are disclosed in U.S. Pat. No. 5,091,260. JP61045514 discloses ionomer coatings for metal pipes. U.S. Pat. No. 4,407,893 discloses powder coating processes to produce abrasion resistant pipes with 0.04-inch thick coatings of sand-filled blends comprising polyethylenes and ionomers. U.S. Pat. No. 5,638,871 discloses the extrusion coating of the outer surface of a metal pipe with ionomer compositions. Abrasion resistant ionomer coatings on glass articles are known (U.S. Pat. Nos. 3,836,386, 3,909,487, 3,922,450, 3,984,608 and EP0798053). Abrasion resistant ionomer coatings are disclosed in US2004/0115399 and US2007/0504331.

A shortcoming of prior ionomer pipes, pipe liners and pipe coatings with thicknesses of about 1.5 mm (0.05 inch) and less is their inability to withstand the desirable transport process temperatures and burst strengths. A further shortcoming of these ionomer pipes, pipe liners and pipe coatings is low abrasion resistance, resulting in short service lifetimes.

### SUMMARY OF THE INVENTION

The invention is directed to a pipe- or tube-formed article having an innermost layer wherein the innermost layer has a thickness of about 6.3 to about 102 mm (0.25 to 4 inches) comprising, or prepared from,

an ionomer composition and the ionomer is made from an acid polymer comprising an α-olefin having 2 to 10 carbons and about 5 to about 25 weight % based on the total weight of the acid polymer of an α,β-ethylenically unsaturated carboxylic acid having 3 to 8 carbons; and about 5 to about 90% of the carboxylic acids are neutralized with a metal ion.

The invention is also directed to a method comprising pulling or inserting an article into the interior surface of a metal pipe to produce an ionomer-lined metal pipe wherein the article is characterized above.

The invention also provides a method comprising laying up a film or sheet or comprising an ionomer composition into the interior surface of a metal pipe; heating the metal pipe above the softening point of the ionomer composition; and allowing the metal pipe to cool to produce an ionomer-lined metal pipe wherein the ionomer is characterized above.

The invention also provides a method for transporting an abrasive material comprising obtaining a pipe- or tube-formed article as described above; preparing an abrasive material composition suitable for flowing through the article; flowing the abrasive material composition into one end of the pipe- or tube-formed article and receiving the abrasive material composition out of the other end of pipe- or tube-formed article.

### DETAILED DESCRIPTION OF THE INVENTION

All publications, patent applications, patents, and other references mentioned herein are incorporated by reference in their entirety.

Trademarks are in upper case.

Although methods and materials similar or equivalent to those described herein can be used in the practice or testing of the present invention, suitable methods and materials are described herein.

Unless stated otherwise, all percentages, parts, ratios, etc., are by weight. When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Term “about” is used in describing a value or an end-point of a range, the disclosure includes the specific value or end-point referred to.

As used herein, the terms “comprises,” “comprising,” “includes,” “including,” “containing,” “characterized by,” “has,” “having” or any other variation thereof, are intended to cover a non-exclusive inclusion. The transitional phrase “consisting of” excludes any element, step, or ingredient not specified in the claim, closing the claim to the inclusion of materials other than those recited except for impurities ordinarily associated therewith. The transitional phrase “consisting essentially of” limits the scope of a claim to the specified materials or steps and those that do not materially affect the basic and novel characteristic(s) of the claimed invention. “A ‘consisting essentially of’ claim occupies a middle ground between closed claims that are written in a ‘consisting of’ format and fully open claims that are drafted in a ‘comprising’ format.”

Where applicants have defined an invention or a portion thereof with an open-ended term such as “comprising,” the description is interpreted to also describe such an invention using the terms “consisting essentially of” or “consisting of.”

Use of “a” or “an” are employed to describe elements and components of the invention. This is done merely for convenience and to give a general sense of the invention. This description includes one or at least one and the singular also includes the plural unless it is obvious that it is meant otherwise.

In describing certain polymers it is to be understood that sometimes applicants are referring to the polymers by the monomers used to make them or the amounts of the monomers used to make them. While such a description may not include the specific nomenclature used to describe the final polymer or may not contain product-by-process terminology, any such reference to monomers and amounts is to be interpreted to mean that the polymer is made from those monomers or that amount of the monomers, and the corresponding polymers and compositions thereof.

The materials, methods, and examples herein are illustrative only and, except as specifically stated, are not intended to be limiting.

The compositions and methods described herein can be used to provide long lifetime, highly abrasion-resistant ionomer pipes for a wide variety of mining and other transportation uses over a wide range of environmental conditions. High burst strength may be another attribute of the pipes.

The ionomer pipe may comprise a single layer of the ionomer composition or it may be a multilayer pipe comprising an innermost layer of the ionomer composition and at least one additional layer of a material other than the ionomer composition, selected from the group consisting of thermoplastic material, fiber reinforcement, thermoset resin and metal.

Ionomer Layer Composition

The terms “thermoplastic ionomer polymer”, “ionomer polymer”, “ionomeric polymer”, “ionomer”, and similar terms used herein, refer to a thermoplastic ionomer made from a parent acid dipolymer comprising, consisting essentially of, or prepared from copolymerized units of an α-olefin having 2 to 10 carbons and about 5 to about 25 weight % of an α,β-ethylenically unsaturated carboxylic acid having 3 to 8 carbons, based on the total weight of the parent acid copolymer, wherein about 5 to about 90% of the carboxylic acids are neutralized with a metal ion.

Preferred α-olefins include but are not limited to ethylene, propylene, 1-butene, 1-pentene, 1-hexene, 1-heptene, 3-methyl-1-butene, 4-methyl-1-pentene, and the like and mixtures thereof. More preferably, the α-olefin is ethylene.

Preferably, the parent acid dipolymer comprises about 7 to about 20 weight %, or more preferably about 8 to about 19 weight %, of groups from the α,β-ethylenically unsaturated carboxylic acid, based on the total weight of the parent acid dipolymer. The α,β-ethylenically unsaturated carboxylic acid comonomers include but are not limited to acrylic acid, methacrylic acid, itaconic acid, maleic acid, maleic anhydride, fumaric acid, monomethyl maleic acid, and mixtures thereof. Preferred are acrylic acid, methacrylic acid and mixtures thereof.

The parent acid dipolymers may be polymerized as disclosed in U.S. Pat. Nos. 3,404,134, 5,028,674, 6,500,888, and 6,518,365. They may be neutralized as disclosed in U.S. Pat. No. 3,404,134. The ionomers are neutralized from about 5 to about 90%, or preferably, from about 10 to about 50%, or more preferably, from about 20 to about 40%, with metal ions, based on the total carboxylic acid content of the parent acid copolymers as calculated for the non-neutralized parent acid copolymers.

The metal ions may be monovalent, divalent, trivalent, multivalent, or mixtures thereof including sodium, potassium, lithium, silver, mercury, copper, beryllium, magnesium, calcium, strontium, barium, copper, cadmium, mercury, tin, lead, iron, cobalt, nickel, zinc, aluminum, scandium, iron, yttrium, titanium, zirconium, hafnium, vanadium, tantalum, tungsten, chromium, cerium, iron, and the like, and mixtures thereof. When the metallic ion is multivalent, complexing agents such as stearate, oleate, salicylate, and phenolate radicals may be included, as disclosed in U.S. Pat. No. 3,404,134. The metallic ions are preferably monovalent or divalent metallic ions. More preferably, the metallic ions are selected from the group consisting of sodium, lithium, magnesium, zinc and mixtures thereof, yet more preferably, sodium, zinc and mixtures thereof. Most preferably, the metallic ions are zinc.

Preferably, the ionomer has a melting point of about 80° C. or higher, more preferably about 90° C. or higher and most preferably about 95° C. or higher. The ionomer layer provides the high thermal resistance to the pipe required by many demanding uses.

Suitable ionomers are commercially available from E.I. du Pont de Nemours and Company (DuPont), Wilmington, Del. Preferred ionomers include SURLYN 7930, SURLYN 8140, SURLYN 8150, SURLYN 8920, SURLYN 8945, SURLYN 9120, SURLYN 9150, SURLYN 9910, SURLYN 9945, SURLYN 9950 and SURLYN 9970 with melting points of about 80° C. or higher; SURLYN 7940, SURLYN 8527, SURLYN 8940, SURLYN 9650 and SURLYN 9721 with melting points of about 90° C. or higher; and SURLYN 8660 and SURLYN 9520 with melting points of about 95° C. or higher.

The ionomer may have Shore D hardness (ASTM D2240, ISO 868) from about 30 to about 70, notably about 30 to about 60, about 40 to about 50, or about 60 to about 70.

A preferred ionomer is a poly(ethylene-co-methacrylic acid) wherein 20 to 60% of the methacrylic acids are neutralized with zinc ions or a combination of sodium and zinc ions.

The ionomer compositions may include additives known in the art. The additives include plasticizers, processing aids, flow enhancing additives, flow reducing additives, lubricants, flame retardants, impact modifiers, nucleating agents to increase crystallinity, antiblocking agents such as silica, thermal stabilizers, UV absorbers, UV stabilizers, dispersants, surfactants, chelating agents, coupling agents, adhesives, primers and the like. One of ordinary skill in the art will recognize that additives may be added to the ionomer composition using techniques known in the art or variants thereof, and will know the proper amounts for addition based upon typical usage. The total amount of additives used in the composition may be up to about 15 weight % based upon the weight of the ionomer composition.

The ionomer compositions may contain additives that effectively reduce the melt flow of the resin, and may be present in any amount that permits production of thermoset compositions. Use of such additives may enhance the upper end-use temperature and reduce creep of the pipes produced therefrom. Such cured compositions may also have enhanced resistance to the low molecular weight aromatic fraction and naptha commonly found in oil sand slurries.

Melt flow reducing additives include organic peroxides such as 2,5-dimethylhexane-2,5-dihydroperoxide, 2,5-dimethyl-2,5-di(tert-butylperoxy)hexane-3, di-tert-butyl peroxide, tert-butylcumyl peroxide, 2,5-dimethyl-2,5-di(tert-butylperoxy)hexane, dicumyl peroxide, α,α′-bis(tert-butyl-peroxyisopropyl)benzene, n-butyl-4,4-bis(tert-butylperoxy)valerate, 2,2-bis(tert-butylperoxy)butane, 1,1-bis(tert-butyl-peroxy)cyclohexane, 1,1-bis(tert-butylperoxy)-3,3,5-trimethyl-cyclohexane, tert-butyl peroxybenzoate, benzoyl peroxide, and the like and mixtures combinations thereof. Preferably the organic peroxides decompose at a temperature of about 100° C. or higher to generate radicals. More preferably, the organic peroxides have a decomposition temperature that affords a half life of 10 hours at about 70° C. or higher to provide improved stability for blending operations. The organic peroxides may be added at a level of about 0.01 to about 10 wt %, or about 0.5 to about 3 wt %, based on the total weight of the ionomer composition.

If desired, initiators, such as dibutyltin dilaurate, may also be present in the ionomer composition at a level of about 0.01 to about 0.05 wt %, based on the total weight of the ionomer composition. Also if desired, inhibitors such as hydroquinone, hydroquinone monomethyl ether, p-benzoquinone, and methylhydroquinone, may be added for the purpose of enhancing control of the reaction and stability. The inhibitors may be added at a level of less than about 5 wt %, based on the total weight of the composition.

Alternative melt flow reducing additives include known peroxide-silanol additives that often include a peroxide (as described above), a silane and a catalyst. These additive systems provide moisture curable materials. Such systems may be added in a concentrate form, such as commercially available under the SILCAT trademark (Momentive Performance Materials, Wilton, Conn., USA).

The ionomer composition may further comprise about 0.1 to about 80 weight % filler based on the total weight of the filled composition.

Preferably, the filler is abrasion-resistant filler. The filler may be reinforcing filler or non-reinforcing filler. Specific examples of preferred reinforcing fillers include high strength fibers such as fiberglass, continuous glass fiber, polyaramide fiber, KEVLAR (aramid fiber, a product of DuPont, one or more fibers made from one or more aromatic polyamides, wherein at least 85% of the amide (—CONH—) linkages are attached directly to two aromatic rings), graphite, carbon fiber, silica, quartz, ceramic, silicon carbide, boron, alumina, alumina-silica, polyethylene, ultrahigh molecular weight polyethylene, polyimide, liquid crystal polymers, polypropylene, polyester, polyamide and the like. For example, US2006/0124188 and US2006/0151042 disclose fiber-reinforced pipe liners. Specific examples of non-reinforcing fillers include particles of abrasion-resistant minerals, marble, slate, granite, sand, potters' sand, silicates, limestone, clay, glass, quartz, metallic powders, aluminum powders, stainless steel powders, zinc metal, refractory metal borides (such as borides of aluminum, niobium, silicon, tantalum, titanium, tungsten, and zirconium), carbides (such as carbides of boron, niobium, silicon, tantalum, titanium, tungsten and zirconium), nitrides (such as nitrides of aluminum, boron, niobium, silicon, tantalum, titanium, tungsten and zirconium), oxides (such as oxides of aluminum, niobium, silicon, tantalum, titanium, tungsten and zirconium), silicon carbide, alumina, fused combinations of alumina and zirconia, calcium carbonate, barium sulfate, magnesium silicate and the like and combinations thereof.

The size of the filler incorporated in the ionomer composition depends on the thickness and diameter of the ionomer pipe and is smaller than the thickness of the ionomer pipe. Preferably, a mixture of particle sizes is used to provide a higher density (percentage by volume) of filler incorporated. For abrasion-resistant fillers, this will result in higher abrasion resistance of the filled pipe. Filled polymeric pipes are known (U.S. Pat. Nos. 3,498,827, 4,042,559, 4,254,165, 4,407,893, 5,091,260, 5,562,989, and GB2028461).

Ionomer Pipe

The article in the form of a pipe comprises an innermost layer having a thickness of about 6.3 to about 102 mm (about 0.25 to about 4 inches) comprising an ionomer composition described above. The pipe may have a hollow circular profile and the wall thickness may be uniform around the circumference of the pipe, or the pipe may have any profile and the wall thickness may vary around the circumference of the pipe as desired, provided it is at least about 6.3 mm. The ionomer composition is positioned as the innermost layer to provide desirably superior abrasion-resistance. The ionomer pipe thickness provides not only a long lifetime under extreme abrasive use conditions, but also provides desirable high burst strength under the high temperature conditions contemplated herein.

Preferably, the ionomer layer has a thickness of about 9.5 to about 76 mm (about 0.375 to about 3 inches), more preferably about 13 to about 51 mm (about 0.5 to about 2 inches), to provide even increased levels of use lifetime, burst strength and temperature resistance.

The ionomer pipe may have any dimensions (including outside diameter, inside diameter and length) required to meet the end use needs. For example but not limitation the ionomer pipe preferably has an outer diameter (OD) of about 2.54 to about 254 cm (about 1 to about 100 inches), more preferably about 25.4 to about 152 cm (about 10 to about 60 inches) and most preferably about 51 to about 102 cm (about 20 to about 40 inches). For example but not limitation the ionomer pipe preferably has a length of about 1.5 to about 12.2 m (about 5 to about 40 feet), more preferably about 3.1 to about 9.1 m (about 10 to about 30 feet) and most preferably about 5.5 to about 6.7 m (about 18 to 22 feet) to provide a convenient length for storage, transport, handling and installation.

The ionomer pipe may be produced by any suitable process. For example, the ionomer pipe may be formed by melt extrusion, melt coextrusion, slush molding, rotomolding, rotational molding or any other procedures known in the art. For example, the ionomer pipe may be produced by rotational or slush molding processes. The ionomer composition may be in the form of powder, microbeads or pellets for use in rotational molding processes. Methods for rotational molding of pipes are known (U.S. Pat. No. 4,115,508; U.S. Pat. No. 4,668,461; and ZA 9607413). ZA9607413 discloses wear-resistant composite pipe linings produced by rotational molding a mixture of a polymeric material with an abrasion-resistant particulate material. Methods for rotational molding with polymer powders are known (U.S. Pat. Nos. 3,784,668; 3,876,613; 3,891,597; 3,974,114; 4,029,729; 4,877,562; 5,366,675; 5,367,025; and 5,759,472). U.S. Pat. No. 3,974,114 discloses rotational molding of articles with poly(ethylene-co-acrylic acid) copolymer powders. Methods for rotational molding with polymer microbeads are known (U.S. Pat. No. 5,886,068; EP1422059; and EP1736502). U.S. Pat. No. 5,886,068 discloses rotational molding processes using blends of micropellets that include ionomers. Methods for rotational molding with polymer pellets are known (U.S. Pat. Nos. 4,032,600; 4,185,067; and 5,232,644). Methods for slush molding with polymer powders are known (U.S. Pat. No. 6,218,474 and EP1169390). EP1169390 discloses ionomer powder compositions used in slush molding processes.

Preferably, the ionomer pipes are formed by melt extrusion and coextrusion processes that are particularly preferred processes for formation of “endless” products. Methods for extruding polymers in the form of pipe are known (U.S. Pat. Nos. 2,502,638; 3,538,209; 3,561,493; 3,755,168; 3,871,807; 3,907,961; 3,936,417; 4,069,001; 4,123,487; 4,125,585; 4,196,464; 4,203,880; 4,301,060; 4,377,545; 4,402,658; 4,465,449; 4,663,107; 4,888,148; 5,028,376; 5,089,204; 5,514,312; 5,518,036; 5,643,526; 5,842,505; 5,976,298; 6,174,981; 6,241,840; 6,418,732; 6,469,079; 6,787,207; US20050167892; US20070117932; EP0222199; EP1574 772; WO95/07428; WO2000/018562; WO2006/090016; and WO2006/134228). The molten polymer is forced through an annular die and a mandrel to provide the hollow circular profile of the pipe with the inner pipe diameter controlled by the size of the mandrel. The diameter of the pipe may also be controlled through the application of air pressure inside the pipe. The outer diameter may be controlled with external sizing dies or sleeves. The pipe is cooled to form the final shape. Multilayer pipe is produced similarly using a multilayer annular die that is fed by two or more extruders.

Multilayer Ionomer Pipe

The article may be a multilayer pipe comprising an innermost layer of the ionomer composition having a thickness of about 6.3 to about 102 mm and an outside layer comprising a polymeric material. Examples of preferred polymeric materials for the outside layer include poly(meth)acrylics, polyacrylates, urethane modified polyacrylics, polyester modified polyacrylics, polystyrenes, polyolefins, polyethylenes (such as high density polyethylene, low density polyethylene, linear low density polyethylene, ultralow density polyethylene), polypropylenes, polyurethanes, polyureas, epoxy resins, polyesters (such as poly(ethylene terephthalate), poly(1,3-propyl terephthalate), poly(1,4-butylene terephthalate), PETG, poly(ethylene-co-1,4-cyclohexanedimethanol terephthalate)), alkyd resins, polyamides (such as nylons, nylon 6, nylon 46, nylon 66, nylon 612), polyamideimides, polyvinyls, phenoxy resins, amino resins, melamines, chlorine-containing resins, chlorinated polyethers, fluorine-containing resins, polyvinyl acetals, polyvinyl formals, poly(vinyl butyrate)s, polyacetylenes, polyethers, silicone resins, ABS resins, polysulfones, polyamine sulfones, polyether sulfones, polyphenylene sulfones, polyvinyl chlorides, polyvinylidene chlorides, polyvinyl acetates, polyvinyl alcohols, polyvinyl carbazoles, butyrals, polyphenylene oxides, polypyrroles, polyparaphenylenes, ultraviolet-curing resins, cellulose derivatives, diethylene glycol bis-allyl carbonate poly-4-methylpentene, polytetrafluoroethylene, polytrifluoroethylene, polyvinylidene fluoride, poly(ethylene-co-glycidylmethacrylate), poly(ethylene-co-methyl (meth)acrylate-co-glycidyl acrylate), poly(ethylene-co-n-butyl acrylate-co-glycidyl acrylate), poly(ethylene-co-methyl acrylate), poly(ethylene-co-ethyl acrylate), poly(ethylene-co-butyl acrylate), acid copolymers, acid terpolymers, poly(ethylene-co-(meth)acrylic acid), ionomers, ionomer terpolymers, metal salts of poly(ethylene-co-(meth)acrylic acid), poly((meth)acrylates), poly(ethylene-co-carbon monoxide), poly(ethylene-co-vinyl acetate), poly(ethylene-co-vinyl alcohol), polybutylene, poly(cyclic olefins), syndiotactic polystyrene, poly(4-hydroxystyrene), novalacs, poly(cresols), polycarbonates, poly(bisphenol A carbonate), polysulfides, poly(phenylene sulfide), poly(2,6-dimethylphenylene oxide), elastomers, rubbers, thermoplastic elastomers and the like and copolymers thereof and mixtures thereof.

More preferably, the polymeric materials are selected from the group consisting of rubbers, elastomers, thermoplastic elastomers, acid terpolymers, ionomer terpolymers and the like and combinations thereof. Rubbers and elastomers may be categorized as diene elastomers, saturated elastomers, thermoplastic elastomers and inorganic elastomers.

Examples of rubbers and elastomers include natural rubber, polyisoprene, butyl rubber (copolymer of isobutylene and isoprene), polybutadiene, styrene butadiene (SBR, copolymer of polystyrene and polybutadiene), nitrile rubber (copolymer of polybutadiene and acrylonitrile, also referred to as “buna N rubbers”), silicone RTV, FKM VITON (DuPont) (copolymer of vinylidene fluoride and hexafluoropropylene), SANTOPRENE (Advanced Elastomer Systems, LP, Akron, Ohio), fluorosilicone rubber, EPM and EPDM rubber (ethylene propylene rubber, a copolymer of polyethylene and polypropylene), polyurethane rubber, polyurea rubber, resilin, polyacrylic rubber (ABR), epichlorohydrin rubber (ECO), polysulfide rubber, chlorosulfonated polyethylene (CSM, HYPALON (DuPont)) and the like. Thermoplastic elastomers include styrenics (S-TPE), copolyesters (COPE), polyurethanes (TPU), polyamides (PEBA), polyolefin blends (TPO), polyolefin alloys (TPV), reactor TPO (R-TPO), polyolefin plastomers (POP), polyolefin elastomers (POE) and the like. Acid terpolymers are made from α-olefins, α,β-ethylenically unsaturated carboxylic acids and preferably about 10 to about 25 weight % other unsaturated comonomers (all as described above). Ionomer terpolymers are made from the parent acid terpolymers through neutralization of a portion of the carboxylic acids, as described above.

The polymer material layer may have any thickness. Preferably, the polymer material layer is about 0.1 to about 102 mm (about 0.004 to about 4 inches), or about 1 to about 25.4 mm (about 0.04 to about 1 inch) or about 2.5 to about 12.7 mm (about 0.1 to about 0.5 inch) thick.

Tielayers may be included between any of the layers to enhance the adhesion between the layers. Any material may be used in tielayers, such as anhydride- or acid-grafted materials. The preferred anhydrides and acids are α,β-ethylenically unsaturated carboxylic acid comonomers selected from the group consisting of acrylic acid, methacrylic acid, itaconic acid, maleic acid, maleic anhydride, fumaric acid, monomethyl maleic acid, and mixtures thereof. Most preferred acids and anhydrides are selected from the group consisting of acrylic acid, maleic anhydride and mixtures thereof. Preferably, the materials to be grafted are selected from the preferred polymeric materials recited above.

Fiber-Reinforced Ionomer Pipe

The article may be in the form of a multilayer pipe comprising an innermost layer having a thickness of about 6.3 to about 102 mm (0.25 to 4 inches) comprising an ionomer composition, as described above, and an outer layer comprising fiber reinforcement and optionally a thermoset resin.

The article may be in the form of a multilayer pipe comprising an innermost layer having a thickness of about 6.3 to about 102 mm (0.25 to 4 inches) comprising an ionomer composition, as described above; an intermediate layer comprising a polymeric material; and an outer layer comprising fiber reinforcement and optionally a thermoset resin.

The fiber reinforcement may be a filament, warp yarn, tape, unidirectional sheet, mat, cloth, knitted cloth, paper, non-woven fabric or woven fabric, or mixtures thereof. The fiber preferably comprises a high strength fiber such as fiberglass, continuous glass fiber, polyaramide fiber, aramid fiber, graphite, carbon fiber, silica, quartz, ceramic, silicon carbide, boron, alumina, alumina-silica, polyethylene, ultrahigh molecular weight polyethylene, polyimide, liquid crystal polymers, polypropylene, polyester, polyamide and the like, and is preferably about 3 to about 30 microns thick.

The fiber may be impregnated with a resin (“prepreg”), such as thermoplastic or preferably thermoset resins. Suitable resins for impregnating the fiber layers include polyester, aromatic, aliphatic, cycloaliphatic or anhydride epoxy resins, vinylester, vinyl, acrylic, modified acrylic, urethane, phenolic, polyimide, bismaleimide, polyurea, siloxane-modified resins and the like and combinations thereof.

Fiber-reinforcement of thermoplastic pipe is known (U.S. Pat. Nos. 4,081,302; 4,521,465; 5,629,062; 5,931,198; 6,737,134; 7,018,691; US2006/0151042; and WO2004/068016).

An adhesive may be applied to the ionomer pipe and multilayer ionomer pipe prior to the application of the exterior reinforcement layer and/or an adhesive may be applied to the reinforcement layer after its application to the ionomer pipe and multilayer ionomer pipe. The exterior surface of the ionomer pipe and multilayer ionomer pipe may be heated to enhance the adhesion and/or embedding of the reinforcement layer. Suitable adhesives may include the impregnated resins described above or any adhesive known in the art.

The fiber reinforcement may be applied to the ionomer pipe and multilayer ionomer pipe by any known method. For example, the fiber reinforcement may be applied using known filament winding processes through winding the fiber reinforcement onto the ionomer pipe and multilayer ionomer pipe or by wrapping the fiber reinforcement around the ionomer pipe and multilayer ionomer pipe.

Ionomer-Lined Metal Pipe.

The article may be in the form of a multilayer pipe comprising an innermost layer comprising the terionomer composition and an outer layer comprising a metal, preferably in the form of a metal pipe.

The monolayer or multilayer ionomer composition (such as in the form of pipe, film, or sheet) may be attached (adhered) to the metal outer layer or not attached. The ionomer or multilayer ionomer compositions may be self-adhered to the metal layer or adhered through the use of an adhesion primer, coating, or layer. As used herein, when the ionomer composition is said to be “self-adhered” to the metal layer, it is meant that there is no intermediate layer such as a primer or thin adhesive layer between the metal and the ionomer or multilayer ionomer composition. The ionomer compositions described herein have the advantage of forming high adhesion to the metal pipe.

The pipe may comprise an innermost layer comprising the ionomer composition; an intermediate layer comprising a polymer material (such as those polymeric materials described above); and an outer layer comprising metal.

The pipe may comprise an innermost layer comprising the ionomer composition; an intermediate layer comprising a polymer material; and an outer layer comprising metal, wherein the ionomer layer is adhered to the polymer material layer and the polymer material layer is adhered to the metal layer.

The pipe may comprise an innermost layer comprising the ionomer composition; an intermediate layer comprising a polymer material; and an outer layer comprising metal, wherein the ionomer layer is self-adhered to the polymer layer and the polymer layer is self-adhered to the metal layer.

The pipe may further comprise an intermediate layer comprising a fiber reinforcement material comprising a high strength fiber and optionally a thermoset resin as described above.

Preferably, the metal pipe comprises carbon steel, steel, stainless steel, cast iron, galvanized steel, aluminum, copper and the like. More preferably the metal pipe comprises carbon steel to provide the physical properties required for the material conveying processes contemplated herein.

The metal pipe may have any dimensions, including thickness, outer diameter, inner diameter and length suitable for the intended use. The pipe may have a hollow, substantially circular profile and the wall thickness may be generally uniform around the circumference of the pipe, or the pipe may have any profile and the wall thickness may vary around the circumference of the pipe as desired. For example but not limitation, the metal pipe may have a thickness of about 6.3 to about 51 mm (about 0.25 to about 2 inches, about 9.5 to about 38 mm (about 0.375 to about 1.5 inches) or about 13 to about 25.4 mm (about 0.5 to about 1 inch). For example but not limitation, the metal pipe may have an outer diameter (OD) of about 5.1 to about 254 cm (about 2 to about 100 inches), about 25.4 to about 152 cm (about 10 to about 60 inches) or about 51 to about 102 cm (about 20 to about 40 inches). For example but not limitation the metal pipe may have a length of about 1.5 to about 12.2 m (about 5 to about 40 feet), about 3.1 to about 9.1 m (about 10 to about 30 feet) or about 5.5 to about 6.7 m (about 18 to 22 feet) to provide a convenient length for storage, transport, handling and installation.

The ionomer-lined metal pipe may be produced by any known method. Monolayer or multilayer ionomer pipe may serve as a liner for a metal pipe. Methods for lining a pipe with a polymeric liner are known (U.S. Pat. Nos. 3,315,348; 3,429,954; 3,534,465; 3,856,905; 3,959,424; 4,207,130; 4,394,202; 4,863,365; 4,985,196; 4,998,871; 5,072,622; 5,320,388; 5,374,174; 5,395,472; 5,551,484; 5,810,053; 5,861,116; 6,058,978; 6,067,844; 6,240,612; 6,723,266; US2006/0093436; US2006/0108016; US2006/0124188; US2006/0151042; and EP0848659).

The inside surface of the metal pipe may be pretreated to provide enhanced adhesion and stability. Such treatments include descaling by sand-, metal grit- or shot-blasting, acid etching, cleaning the metal surface through solvent or chemical washes to remove grease and/or oxide layers, and the application of adhesion primers, coatings, or layers.

An ionomer-lined metal pipe may be prepared by pulling or inserting a preformed ionomer pipe or multilayer ionomer pipe comprising an innermost layer having a thickness of about 6.3 to about 102 mm comprising an ionomer composition as described above into a preformed metal pipe wherein the outer diameter of the ionomer pipe is less than the interior diameter of the metal pipe. This method to produce an ionomer-lined metal pipe includes the following embodiments.

The method comprises (i) pulling or inserting a pre-formed ionomer pipe or multilayer ionomer pipe into the metal pipe; (ii) heating the ionomer-lined metal pipe above the softening point of the ionomer composition; and (iii) allowing the metal pipe to cool.

The method comprises (i) heating a metal pipe above the softening point of the ionomer composition; (ii) pulling or inserting a pre-formed ionomer pipe or multilayer ionomer pipe into the heated metal pipe; and (iii) allowing the metal pipe to cool.

The method comprises (i) coating a layer of an adhesive or adhesion primer onto the outside surface of the ionomer pipe or multilayer ionomer pipe; and (ii) pulling or inserting the adhesive-treated ionomer pipe or multilayer ionomer pipe into the metal pipe.

The method comprises (i) coating a layer of an adhesive or adhesion primer onto the inside surface of the metal pipe; and (ii) pulling or inserting the ionomer pipe or multilayer ionomer pipe into the adhesive-treated metal pipe.

The method comprises (i) coating a layer of an adhesive or adhesion primer onto the outside surface of the ionomer pipe or multilayer ionomer pipe; (ii) pulling or inserting the adhesive-treated ionomer pipe or multilayer ionomer pipe into the metal pipe; (ii) heating the metal pipe above the softening point of the ionomer composition; and (iv) allowing the metal pipe to cool.

The method comprises (i) coating a layer of an adhesive or adhesion primer onto the inside surface of the metal pipe; (ii) pulling or inserting the ionomer pipe or multilayer ionomer pipe into the adhesive-treated metal pipe; (ii) heating the metal pipe above the softening point of the ionomer composition; and (iv) allowing the metal pipe to cool.

The method comprises (i) coating a layer of an adhesive or adhesion primer onto the outside surface of the ionomer pipe or multilayer ionomer pipe; (ii) heating a metal pipe above the softening point of the ionomer composition; (iii) pulling or inserting the adhesive-treated ionomer pipe or multilayer ionomer pipe into the heated metal pipe; and (iv) allowing the metal pipe to cool.

The method comprises (i) coating a layer of an adhesive or adhesion primer onto the inside surface of the metal pipe; (ii) heating the adhesively-treated metal pipe above the softening point of the ionomer composition; (iii) pulling or inserting the ionomer pipe or multilayer ionomer pipe into the heated metal pipe; and (iv) allowing the metal pipe to cool.

In a specific embodiment, the method for adhering the ionomer pipe or multilayer ionomer pipe to the metal pipe comprises (a) descaling and cleaning the interior surface of the metal pipe; (b) heating the metal pipe to a temperature of about 150 to about 400° C., preferably about 150 to about 300° C. and most preferably of about 175 to about 225° C.; (c) pulling or inserting the ionomer liner (pipe) or ionomer multilayer liner (pipe) into the hot metal pipe; and (d) allowing the ionomer-lined metal pipe to cool to ambient conditions.

For example, preparing an ionomer lined metal pipe method with a self-adhered liner (pipe) includes descaling, degreasing and cleaning as described above. The metal pipe is then heated, as in an oven, a furnace, a gas ring burner, electrical resistive heating elements, radiant heaters, induction heating, high frequency electrical heaters and the like, and the heating may be discontinued throughout the remainder of the process or the metal pipe may be continuously heated, as through induction heating, throughout the process. The heating expands the metal pipe. An ionomer liner (pipe) or ionomer multilayer liner (pipe) is pulled or inserted into the hot metal pipe. The ionomer and multilayer ionomer liner preferably has an outside diameter (OD) that is no greater than about 0.1 inch (2.5 mm) less than the inside diameter (ID) of the unheated metal pipe, more preferably an OD no greater than about 0.05 inch (1.3 mm) less than the ID, even more preferably, an OD no greater than about 0.025 inch (0.64 mm) less than the ID. Most preferably, the ionomer and multilayer ionomer liner OD is about equivalent to the ID of the unheated metal pipe. As the heated metal pipe-ionomer liner structure cools, the metal pipe reduces in diameter and makes intimate contact with the outside surface of the ionomer liner, causing it to soften and self-adhere to the inside surface of the metal pipe. Alternatively, the ionomer liner (pipe) or multilayer ionomer liner (pipe) may be inserted into the metal pipe prior to heating.

If desired, prior to heating the metal pipe and inserting the ionomer and multilayer ionomer liner (pipe), an adhesive primer, coating or layer may be applied to the interior surface of the metal pipe, the exterior surface of the ionomer and multilayer ionomer liner or both, in the form of a solution or solid to provide enhanced interlayer adhesion.

A method to produce an ionomer-lined metal pipe comprises laying up a pre-formed ionomer film or sheet or multilayer ionomer film or sheet into a preformed metal pipe. This method to produce an ionomer-lined metal pipe includes the following embodiments.

The method comprises (i) laying up the interior of a metal pipe with ionomer film or sheet or multilayer ionomer film or sheet; (ii) heating a metal pipe above the softening point of the ionomer composition; and (iii) allowing the metal pipe to cool.

The method comprises (i) coating a layer of an adhesive or adhesion primer onto the outside surface of the ionomer film or sheet or multilayer ionomer film or sheet; and (ii) laying up the interior of a metal pipe with ionomer film or sheet or multilayer ionomer film or sheet.

The method comprises (i) coating a layer of an adhesive or adhesion primer onto the inside surface of the metal pipe; and (ii) laying up the interior of a metal pipe with ionomer film or sheet or multilayer ionomer film or sheet.

The method comprises (i) coating a layer of an adhesive or adhesion primer onto the outside surface of the ionomer film or sheet or multilayer ionomer film or sheet; (ii) laying up the interior of a metal pipe with ionomer film or sheet or multilayer ionomer film or sheet; (iii) heating a metal pipe above the softening point of the ionomer composition; and (iv) allowing the metal pipe to cool.

The ionomer film or sheet and the multilayer ionomer film or sheet may be produced by any art method. Preferably the film or sheet is produced through melt processes, such as extrusion blown film processes, extrusion film or sheet melt casting processes, sheet profile extrusion processes, calendar processes and the like. The films and sheets may undergo secondary formation processes, such as the plying together of preformed sheets to produce thicker sheets through known calendaring processes.

An example ionomer lined metal pipe method with a self-adhered ionomer sheet includes descaling the interior of the metal pipe, followed by degreasing and cleaning. The interior of the metal pipe is then covered with the ionomer sheet, preferably with the sheet overlapping onto itself 0.5 to 4 inches to form a seam. The seam may be heat fused or the excess sheet may be trimmed and the sheet ends may be heat fused, as desired. The metal pipe is then heated, as described above, to the temperature range of about 150 to about 400° C., preferably to the temperature range of about 150 to about 300° C. and most preferably to the temperature range of about 175 to about 225° C. As the heated metal pipe-ionomer sheet structure cools, the metal pipe makes intimate contact with the outside surface of the ionomer sheet, causing it to soften and self-adhere to the inside surface of the metal pipe.

If desired, prior to heating the metal pipe and inserting the ionomer and multilayer ionomer film or sheet, an adhesive primer, coating or layer may be applied to the interior surface of the metal pipe, the exterior surface of the ionomer and multilayer ionomer film or sheet or both, in the form of a solution or solid to provide enhanced interlayer adhesion.

The ionomer-lined metal pipe may be produced by powder coating processes. Methods for coating the inner or outer surfaces of a pipe with polymeric powder coatings are known (U.S. Pat. Nos. 3,004,861; 3,016,875; 3,063,860; 3,074,808; 3,138,483; 3,186,860; 3,207,618; 3,230,105; 3,245,824; 3,307,996; 3,488,206; 3,532,531; 3,974,306; 3,982,050; 4,007,298; 4,481,239; and EP778088). For example, U.S. Pat. No. 4,407,893 discloses powder coating processes to produce abrasion-resistant pipes with 0.04-inch thick coatings of sand-filled blends comprising polyethylenes and ionomers and U.S. Pat. No. 6,680,082 discloses ionomer powders neutralized with more than one metal ion and their use as metal coatings.

The ionomer composition may be produced in the form of a powder by any known method. Methods for producing powders comprising acid copolymers and ionomers, and powder coating compositions are known (U.S. Pat. Nos. 3,933,954; 3,959,539; 4,056,653; 4,237,037; 5,344,883; 6,107,412; 6,132,883; 6,284,311; 6,544,596; 6,680,082; and EP1169390). Preferably, the ionomer composition is cryogenically (for example, with liquid nitrogen as the cooling medium) ground into a powder. Physically grinding the ionomer composition creates irregularly shaped particles of size and shape suitable for achieving constant flow through the application equipment. Preferably, the ionomer composition powder has a particle size or average particle size of about 20 to about 500 micrometers. To obtain the suitable particle size, the grinding step may include a sieving or classification step to eliminate large- and fine-sized particles. For fluid bed coating processes, the preferred particle size is of about 75 to about 350 micrometers.

A method to produce a ionomer-lined metal pipe comprises (i) heating a metal pipe above the softening point of an ionomer composition; (ii) fluidizing the ionomer composition in the form of a powder; (iii) supplying the fluidized ionomer composition powder to the inside of the heated metal pipe until the desired ionomer thickness is achieved; and (iv) allowing the metal pipe to cool.

The heated metal pipe may be in a vertical orientation during step (iii); or the heated metal pipe may be in a horizontal orientation during step (iii). In another embodiment, the heated metal pipe may be rotated during step (iii). For example, the heated metal pipe may be rotated at a rate to force the ionomer composition powder to the inside diameter of the metal pipe during step (iii).

The powder coating process comprises heating the metal pipe to a temperature above the softening point of the ionomer composition and supplying a fluidized powder of the ionomer composition into the heated pipe for a time sufficient to provide the desired ionomer coating thickness. The metal pipe is preferably heated to the temperature range of about 150 to about 400° C., preferably about 200 to about 350° C. and most preferably about 250 to about 300° C. The metal pipe may be heated as described above and the heating may be discontinued throughout the remainder of the process or the metal pipe may be continuously heated throughout the process. In addition, portions of the pipe may be heated. For example, in a fluidized bed method (see below) the metal pipe may be incrementally heated from the top to the bottom to cause the coating to form sequentially from the top to the bottom. Conversely, the metal pipe may be heated from the bottom to the top.

The ionomer coating may be self-adhered to the metal pipe or the interior surface of the metal pipe may be treated with adhesion primers, coatings and layers. The use of adhesion promoting primers and coupling agents for pipe powder coatings is known (U.S. Pat. Nos. 3,016,875; 4,048,355; and 4,481,239).

Pipe powder coating methods may include descaling, degreasing and cleaning as described above. The portions of the pipe which are not desired to be coated, for example the metal pipe ends which are meant to be joined together to form the pipeline, may be masked. If desired, prior to feeding the powder, an adhesive primer, coating or layer may be applied to the interior surface of the metal pipe in the form of a solution or solid (powder) to provide enhanced interlayer adhesion. The metal pipe is then heated as described above. The metal pipe temperature may be varied as desired during the coating operation. Preferably, the heated metal pipe may be rotated about its cylindrical axis at a rate of about 1 to about 300 rpm, more preferably about 10 to about 80 rpm. The metal pipe may be rotated slowly to provide good, even coverage of the powder coating or may be rotated fast enough to force the powder to the interior surface of the pipe. The metal pipe may be in a vertical orientation or preferably in a horizontal orientation. If a multilayer coating is desired, different polymeric composition powders may be fed sequentially to provide the different coating layers at the thickness desired. At any stage of the process, abrasion-resistant particles, such as described above as fillers, may be fed into the interior of the metal pipe, either individually or in combination with the powder. For example, the abrasion-resistant particles may be overcoated onto the hot coating while it is still soft and tacky so that the particles adhere to the interior surface of the coating. The coated metal pipe is then allowed to cool to ambient temperatures. If desired, any coating surface roughness may be smoothed through a post-coating operation, such as by hot gas, flame or oven post-treatments.

In a fluidized bed method, the powder is fed with pressurized gas, such as compressed air, nitrogen or argon, from a fluidized bed of the powder into the interior of the hot metal pipe. Alternatively, the hot metal pipe may be placed above the fluidized bed and the fluidized bed allowed to expand into the interior of the hot metal pipe to be coated. As the powder contacts the heated interior surface of the metal pipe, the material coalesces and flows to form a continuous, fused coating. The powder is fed from the fluidized bed until a continuous, uniform coating of the desired thickness is achieved.

In a spray coating method, a spray nozzle, preferably with a deflector disc to force the powder radially out onto the metal pipe interior surface, supported on an extensible boom, is inserted down the centerline of the metal pipe interior. The powder may be fed with pressurized gas, such as compressed air, nitrogen or argon, from a fluidized bed of the powder. Alternatively, the powder may be delivered from a bin to a vibrating feeder into a hopper and then conveyed to the spray nozzle with a pressurized gas. During the coating operation, the spray nozzle, the metal pipe or both may be moved to ensure uniform coating over the interior surface of the pipe. Multiple coats may be applied to provide the desired coating thicknesses.

The ionomer composition powder may be applied to the inside metal pipe surface through electrostatic spraying processes. For electrostatic spraying applications, the preferred particle size is about 20 to about 120 micrometers. Preferably, the metal pipe is preheated above the softening point of the ionomer composition as described above. In electrostatic spraying processes, the ionomer powder is fed out of a reservoir, such as a fluidized bed, to a spray gun by air pressure. A high voltage, low amperage electrostatic charge is applied to the ionomer powder by a transfer of electrons from the spray gun to the powder. The charged powder is sprayed onto the cleaned inside surface of the preheated, grounded metal pipe to form the ionomer coating. Several passes may be needed to provide the desired thickness of the coating.

The ionomer composition coating may be applied to the metal pipe by thermal spraying processes, such as flame (combustion) spraying, two wire arc spraying, plasma spraying, cold spraying and high velocity oxy-fuel spraying. Preferably, the thermal spraying process is a flame spraying process. The ionomer composition may be in the form of a wire or a rod to serve as a feedstock for flame spraying processes, or it is a powder with a preferred particle size of about 1 to about 50 micrometers. The ionomer powder is fed to the flame spraying gun in a stream of an inert gas (such as argon or nitrogen) and fed into a flame of a fuel gas (such as acetylene or propane) and oxygen. The ionomer powder is melted in the flame and with the help of a second outer annular gas nozzle of compressed air is sprayed onto the cleaned inside surface of the preheated metal pipe to form the ionomer coating. Several passes may be required to build up the thickness of the coating. Alternatively, the ionomer powder may be fed to the flame spray gun using a venturi effect sustained by the fuel gas flow.

The ionomer compositions may be too soft for the formation of suitable powder to support powder-based processes. Even if suitable powder were produced from the ionomer compositions, the powder may tend to mass (stick together). Powder-based processes to produce the pipe are therefore not preferred.

The ionomer-lined metal pipe may be produced by processes similar to the above by rotational or slush molding processes. The ionomer composition may be in the form of powder, microbeads or pellets. The coating process comprises heating the metal pipe to a temperature above the softening point of the ionomer composition, horizontally rotating the pipe and supplying the ionomer composition into the heated pipe for a time sufficient to provide the desired ionomer coating thickness. The metal pipe may be preheated (such as in an oven), may be constantly heated during the process or both. The ionomer composition may be fed all at once, batchwise or continuously to the rotating heated metal pipe. After an even coating of the desired thickness of the ionomer composition is applied to the inner diameter of the metal pipe, the pipe is cooled.

The pipes described herein provide high abrasion-resistance and corrosion resistance for the conveyance of solids and slurries such as found in the agriculture, food and mining industries. The ionomer layer in the pipes provides very long lifetime, especially desirable for those industries that require long service lifetime due to the great maintenance and replacement complexity and cost. For example, oil slurry mining operations require kilometers of slurry pipelines in extreme environments, such as northern Alberta, Canada, so extended pipe lifetime is very desirable.

A method for transporting an abrasive material comprises obtaining a pipe- or tube-formed article as described above; preparing an abrasive material composition suitable for flowing through the article; flowing the abrasive material composition into one end of the pipe- or tube-formed article and receiving the abrasive material composition out of the other end of pipe- or tube-formed article. The abrasive material composition may be moved through the pipe by any motive force such as gravity and/or the action of a pump such as a jet pump.

The abrasive material composition may be a slurry, such as a combination of water, oil, air, emulsified materials, particulates, solids and/or the like. A slurry of note is oil sand slurry. In some cases, the abrasive material, such as oil sand slurry, may be at a temperature of about 30° C. or greater, of about 40° C. or greater, or about 50° C. or greater. Oil sand slurries may be prepared as described in, for example, US2006/0249431. The oil sand slurry may be optionally conditioned by transport through the pipe- or tube-formed article, such conditioning comprising for example lump digestion, bitumen liberation, coalescence and/or aeration. Pumping the slurry through a pipeline over a certain minimum distance (such as at least one kilometer, preferably at least 2 kilometers), allows for conditioning the slurry. This is due to the increased time (such as 10 minutes or greater) in the pipeline, which allows transport through the pipeline to replace conditioning of the oil sand in a batch tumbler. In a low energy extraction process, the mined oil sand is mixed with water in predetermined proportions near the mine site to produce a slurry containing entrained air with density of 1.4 to 1.65 g/cc and preferably a temperature of 20-40° C. Pumping the slurry through a pipeline having a plurality of pumps spaced along its length, preferably adding air to the slurry as it moves through the pipeline, conditions the slurry for further operations to extract bitumen from the slurry.

### EXAMPLES

The following Examples are intended to be illustrative of the invention, and are not intended in any way to limit its scope.

Melt Index (MI) was measured by ASTM D1238 at 190° C. using a 2160 g mass, unless indicated otherwise. A similar ISO test is ISO 1133. Shore D hardness was measured according to ASTM D2240, ISO 868.

### Materials Used

ION 1: a poly(ethylene-co-methacrylic acid) with 15 weight % methacrylic acid, partially neutralized with about 27% zinc ions, with MI of about 2 g/10 min.
ION 2: a poly(ethylene-co-methacrylic acid) with 19 weight % methacrylic acid, partially neutralized with about 37% zinc ions, with MI of 1 g/10 min.
ION 3: a poly(ethylene-co-methacrylic acid) with 15 weight % methacrylic acid, partially neutralized with zinc ions, with MI of 5 g/10 min.
ION 4: a poly(ethylene-co-methacrylic acid) with 10 weight % methacrylic acid, partially neutralized with about 30% of a mixture of zinc ions and sodium ions in a 75:25 molar ratio, with MI of about 1 g/10 min.
ION 5: a poly(ethylene-co-methacrylic acid) with 15 weight % methacrylic acid, partially neutralized with about 35% of a mixture of zinc ions and sodium ions in a 50:50 molar ratio, with MI of about 5 g/10 min.
ION 6: a poly(ethylene-co-methacrylic acid) with 19 weight % methacrylic acid, partially neutralized with about 37% of a mixture of zinc ions and sodium ions in a 75:25 molar ratio, with MI of 2 g/10 min.
ION 7: a filled composition of 50 weight % ION 1 and 50 weight % sand based on the total weight of the composition.
ION 8: a filled composition of 25 weight % ION 4 and 75 weight % silica based on the total weight of the composition.
ION 9: a filled composition of 75 weight % ION 5 and 25 weight % marble dust based on the total weight of the composition.
ION 10: an ionomer powder comprising a poly(ethylene-co-methacrylic acid) copolymer with 10 weight % methacrylic acid neutralized with about 20% zinc ions and MI of about 50 g/10 min with an average particle size of about 250 microns.
ION 11: an ionomer powder comprising a poly(ethylene-co-methacrylic acid) copolymer with 15 weight % methacrylic acid neutralized with about 30% zinc ions and MI of about 35 g/10 min with an average particle size of about 200 microns.
ION 12: an ionomer powder comprising a poly(ethylene-co-acrylic acid) copolymer with 15 weight % acrylic acid neutralized with about 40% zinc ions and MI of about 15 g/10 min with an average particle size of about 225 microns.
ION 13: an ionomer powder comprising a poly(ethylene-co-methacrylic acid) copolymer with 14 weight % methacrylic acid, neutralized with about 25% of a mixture of zinc ions and sodium ions in 75:25 molar ratio and MI of about 25 g/10 min with an average particle size of about 250 microns.
ION 14: an ionomer powder comprising a poly(ethylene-co-methacrylic acid) copolymer with 15 weight % methacrylic acid neutralized with about 30% of a mixture of zinc ions and sodium ions in 50:50 molar ratio and MI of about 35 g/10 min with an average particle size of about 200 microns.
ION 15: an ionomer powder comprising a poly(ethylene-co-methacrylic acid) copolymer with 18 weight % methacrylic acid neutralized with about 40% of a mixture of zinc ions and sodium ions in 25:75 molar ratio and MI of about 10 g/10 min with average particle size of about 225 microns.
ION 16: a filled composition of 50 weight % ION 11 and 50 weight % sand based on the total weight of the composition.
ION 17: a filled composition of 25 weight % ION 13 and 75 weight % silica based on the total weight of the composition.
ION 18: a filled composition of 75 weight % ION 14 and 25 weight % marble dust based on the total weight of the composition.
ION 19: a poly(ethylene-co-methacrylic acid) with 15 weight % methacrylic acid, partially neutralized with about 58% zinc ions with MI of about 0.7 g/10 min and Shore D hardness of 64.
ACR: a poly(ethylene-co-n-butylacrylate-co-methacrylic acid) containing 23 weight % n-butylacrylate and 9 weight % methacrylic acid having a MI of 5 g/10 min.
EO: a metallocene-catalyzed ethylene-octene copolymer plastomer, sold as EXACT 5361 by the ExxonMobil Chemical Company (ExxonMobil), Houston, Tex.
EP 1: a metallocene-catalyzed ethylene-propylene copolymer, sold as VISTALON EPM 722 (ExxonMobil).
EP 2: a metallocene-catalyzed copolymer, sold as VISTAMAXX VM1100 (Exxon Mobil).
EP 3: a metallocene-catalyzed copolymer grafted with 2 weight % maleic anhydride.
EPDM: a metallocene-catalyzed ethylene-propylene-diene copolymer, sold as VISTALON 5601 (ExxonMobil).
HDPE 1: a high density poly(ethylene).
HDPE 2: a high density poly(ethylene) grafted with 1.5 weight % maleic anhydride.
S: a styrene block copolymer sold as KRATON G7705-1 by Kraton Polymers (Kraton), Houston, Tex.
SBS: a styrene-butadiene-styrene block copolymer with a MI of3 g/10 min at 200° C./5 kg, sold as KRATON D1153E (Kraton).
SEBS 1: a styrene-ethylene/styrene block copolymer with a MI of 5 g/10 min at 230° C./5 kg, sold as KRATON G1652M (Kraton).
SEBS 2: a styrene-ethylene/styrene block copolymer grafted with 1.7 weight % maleic anhydride, sold as KRATON FG1901X (Kraton).
SEBS 3: a styrene-ethylene/styrene block copolymer grafted with 1 weight % maleic anhydride and is sold as KRATON FG1924X (Kraton).
SIS: a styrene-isoprene-styrene block copolymer with a MI of 3 g/10 min at 200° C./5 kg, sold as KRATON D1 K (Kraton).
TI: a poly(ethylene-co-n-butylacrylate-co-methacrylic acid) containing 23 weight % n-butylacrylate and 9 weight % methacrylic acid that is 40% neutralized with zinc ions and having a MI of 2.5 g/10 min.

Thickness and diameter in the following tables, unless specifically indicated, are in inches (1 inch=2.54 cm).

### Examples 1-9

The ionomer pipes summarized in Table 1 are made from the materials listed by conventional pipe extrusion and sizing methods with melt extrusion temperatures from about 225° C. to about 250° C. The pipes are cut into 20 foot lengths. OD=outer diameter.

TABLE 1

| Example | Material | Outer Diameter | Thickness |
|---|---|---|---|
| 1 | ION 1 | 20 | 0.5 |
| 2 | ION 2 | 24 | 1.0 |
| 3 | ION 3 | 28 | 2.0 |
| 4 | ION 4 | 22 | 0.38 |
| 5 | ION 5 | 26 | 0.75 |
| 6 | ION 6 | 32 | 1.5 |
| 7 | ION 7 | 26 | 0.4 |
| 8 | ION 8 | 30 | 1.0 |
| 9 | ION 9 | 34 | 1.8 |

### Examples 10-15

The bilayer ionomer pipes described in Table 2 are made from the materials summarized in Table 2 through conventional multilayer pipe extrusion and sizing methods with melt extrusion temperatures about 225° C. to about 250° C. The pipes are cut into 20 foot lengths.

TABLE 2

| | Inner Layer | | Outer Layer | | Pipe |
|---|---|---|---|---|---|
| Example | Material | Thickness | Material | Thickness | Outer Diameter |
| 10 | ION 1 | 0.5 | ACR | 0.25 | 20 |
| 11 | ION 3 | 1.0 | EPDM | 0.4 | 24 |
| 12 | ION 5 | 2.0 | HDPE 2 | 0.5 | 28 |
| 13 | ION 5 | 0.38 | SEBS 2 | 0.2 | 22 |
| 14 | ION 7 | 0.75 | SEBS 3 | 0.3 | 26 |
| 15 | ION 9 | 1.5 | TI | 0.5 | 32 |

### Examples 16-24

The multilayer ionomer pipes summarized in Table 3 are made from the materials listed in Table 3 by conventional multilayer pipe extrusion and sizing methods with melt extrusion temperatures of 225° C. to about 250° C. The tielayer is about 1 to 2 mils thick (0.026-0.051 mm) and is positioned between the inner layer and outer layer to provide adhesion. All Examples also have a similar tielayer on the outside surface of the outer layer: the structure of the pipe is tielayer/outer layer/tielayer/inner layer. The pipes are cut into 20 foot lengths.

TABLE 3

| | | | | | | Pipe |
|---|---|---|---|---|---|---|
| Exa- | Inner Layer | | Tie Layer | Outer Layer | | Outer |
| mple | Material | Thickness | Material | Material | Thickness | Diameter |
| 16 | ION 1 | 0.5 | EP3 | EO | 0.25 | 20 |
| 17 | ION 2 | 1.0 | EP3 | EP1 | 0.4 | 24 |
| 18 | ION 3 | 2.0 | EP3 | EP2 | 0.5 | 28 |
| 19 | ION 4 | 0.38 | EP3 | EPDM | 0.2 | 22 |
| 20 | ION 5 | 0.75 | HDPE2 | HDPE 1 | 0.3 | 26 |
| 21 | ION 6 | 1.5 | SEBS 2 | S | 0.5 | 32 |
| 22 | ION 7 | 0.45 | SEBS 3 | SBS | 0.2 | 26 |
| 23 | ION 8 | 1.0 | SEBS 2 | SEBS 1 | 0.1 | 30 |
| 24 | ION 9 | 1.8 | SEBS 2 | SIS | 0.3 | 34 |

### Examples 25-32

The ionomer pipe-lined carbon steel pipes summarized in Table 4 are made by inserting the ionomer pipes listed into 20-foot lengths of carbon steel pipes with 0.75-inch wall thickness with the inner diameter (ID) listed. Prior to lining the pipe, the interior surface carbon steel pipe is sandblasted and degreased.

TABLE 4

| Example | Ionomer Pipe (Example) | Pipe ID |
|---|---|---|
| 25 | 1 | 22 |
| 26 | 5 | 28 |
| 27 | 8 | 30 |
| 28 | 11 | 26 |
| 29 | 15 | 34 |
| 30 | 19 | 24 |
| 31 | 20 | 28 |
| 32 | 21 | 34 |

### Examples 33-40

The ionomer-lined pipelines summarized in Table 5 are made by thermally fusing the ends (“butt fusion”) of the ionomer pipes listed, using conventional methods and inserting the polymeric pipes into the carbon steel pipes with 0.75-inch wall thickness with the length and the inner diameter (ID) listed. Prior to lining the pipe, the interior surface carbon steel pipe is sandblasted and degreased.

TABLE 5

| | Ionomer | Carbon Steel Pipe | |
|---|---|---|---|
| Example | Pipe (Example) | Inner Diameter | Length (km) |
| 33 | 2 | 26 | 1 |
| 34 | 4 | 24 | 2 |
| 35 | 9 | 36 | 3 |
| 36 | 10 | 22 | 0.5 |
| 37 | 12 | 30 | 1.5 |
| 38 | 17 | 26 | 1 |
| 39 | 20 | 28 | 2 |
| 40 | 23 | 32 | 3 |

### Examples 41-64

The ionomer pipe-lined carbon steel pipes summarized in Table 6 are made by heating 20 foot lengths of carbon steel pipes with 0.75-inch wall thickness and the inner diameter (ID) listed to 200° C.; inserting the ionomer pipes listed into the hot carbon steel pipes; and allowing the lined pipe to cool to ambient temperatures. Prior to lining the pipe, the interior surface carbon steel pipe is sandblasted and degreased.

TABLE 6
Ionomer-Lined Carbon Steel Pipes

| Example | Ionomer Pipe (Example) | Inner diameter |
|---|---|---|
| 41 | 1 | 20 |
| 42 | 2 | 24 |
| 43 | 3 | 28 |
| 44 | 4 | 22 |
| 45 | 5 | 26 |
| 46 | 6 | 32 |
| 47 | 7 | 26 |
| 48 | 8 | 30 |
| 49 | 9 | 34 |
| 50 | 10 | 20 |
| 51 | 11 | 24 |
| 52 | 12 | 28 |
| 53 | 13 | 22 |
| 54 | 14 | 26 |
| 55 | 15 | 32 |
| 56 | 16 | 20 |
| 57 | 17 | 24 |
| 58 | 18 | 28 |
| 59 | 19 | 22 |
| 60 | 20 | 26 |
| 61 | 21 | 32 |
| 62 | 22 | 26 |
| 63 | 23 | 30 |
| 64 | 24 | 34 |

### Examples 65-73

Powder-coated carbon steel pipes, summarized in Table 7, are prepared by the following procedure. The interior surface of a 20 foot long length carbon steel pipe with the inner diameter listed is sandblasted and degreased. The pipe is then placed in a vertical orientation and induction heated to a temperature of about 275° C. The ionomer powder listed is fed from a fluidized bed, fluidized with nitrogen gas, by allowing the fluidized bed to expand into the interior of the heated carbon steel pipe from the bottom and allowing it to flow out the top of the pipe. The fluidized bed of ionomer powder is continuously fed into the hot carbon steel pipe until the uniform coating thickness listed is achieved. The ionomer powder feed is then discontinued and the coated carbon steel pipe is then allowed to cool to ambient temperature.

TABLE 7
Ionomer-Lined Carbon Steel Pipes

| Example | Inner diameter | Ionomer Powder | Coating |
|---|---|---|---|
| 65 | 20 | ION 10 | 0.38 |
| 66 | 26 | ION 11 | 1.0 |
| 67 | 30 | ION 12 | 1.5 |
| 68 | 22 | ION 13 | 0.5 |
| 69 | 28 | ION 14 | 0.75 |
| 70 | 34 | ION 15 | 2.0 |
| 71 | 20 | ION 16 | 0.4 |
| 72 | 24 | ION 17 | 0.8 |
| 73 | 32 | ION 18 | 1.0 |

### Examples 74-82

Powder-coated carbon steel pipes, summarized in Table 8, are prepared by the following procedure. The interior surface of a 20 foot long length carbon steel pipe with the inner diameter listed is sandblasted and degreased. The pipe is heated to a temperature of about 350° C. in a gas-fired furnace. The hot pipe is then removed from the furnace and placed on a roller in a horizontal orientation and rolled along its axis at a rate of about 80 rpm. The ionomer powder listed is fed from a fluidized bed, fluidized with nitrogen gas, by allowing the fluidized bed to expand into the interior of the heated carbon steel pipe from one pipe end and allowing it to flow out the other end of the pipe. The fluidized bed of ionomer powder is continuously fed into the hot carbon steel pipe until a uniform coating thickness is achieved. The ionomer powder feed is then discontinued and the coated carbon steel pipe is then allowed to cool to ambient temperature while maintaining rotation of the pipe.

TABLE 8
Ionomer-Lined Carbon Steel Pipes

| Example | Inner diameter | Ionomer Powder | Coating Thickness |
|---|---|---|---|
| 74 | 20 | ION 10 | 0.38 |
| 75 | 26 | ION 11 | 1.0 |
| 76 | 30 | ION 12 | 1.5 |
| 77 | 22 | ION 13 | 0.5 |
| 78 | 28 | ION 14 | 0.75 |
| 79 | 34 | ION 15 | 2.0 |
| 80 | 20 | ION 16 | 0.4 |
| 81 | 24 | ION 17 | 0.8 |
| 82 | 32 | ION 18 | 1.0 |

### Examples 83-91

Powder-coated carbon steel pipes, summarized in Table 9, are prepared by the following procedure. The interior surface of a 20 foot long length carbon steel pipe with the diameter listed is sandblasted and degreased. The carbon steel pipe is heated to a temperature of about 350° C. in a gas-fired furnace. The hot pipe is then removed from the furnace and placed on a roller in a horizontal orientation and rolled along its axis at a rate of about 80 rpm. A radially-directed spray nozzle on the end of an extensible boom is inserted down the centerline of the rotating, hot pipe. The ionomer powder listed is fed from a fluidized bed with compressed air. The spray nozzle is continuously moved up and down the length of the hot metal pipe until the uniform coating thickness listed is achieved. The ionomer powder feed is then discontinued. For Examples 85, 89 and 90, a blend of 25 weight % of the same ionomer powder and 75 weight % of a finely divided sand is overcoated onto the ionomer coating as described above until a uniform depth of 0.1 inch is achieved. Throughout the coating operation, the carbon steel pipe is in the temperature range of from about 300° C. to about 250° C. The coated carbon steel pipe is then allowed to cool while maintaining the rotation until a temperature of about 100° C. is achieved. Rotation is then discontinued and the coated carbon steel pipe is allowed to cool to ambient temperature.

TABLE 9
Ionomer-Lined Carbon Steel Pipes

| Example | Inner diameter | Ionomer Powder | Coating Thickness |
|---|---|---|---|
| 83 | 20 | ION 10 | 0.38 |
| 84 | 26 | ION 11 | 1.0 |
| 85 | 30 | ION 12 | 1.5 |
| 86 | 22 | ION 13 | 0.5 |
| 87 | 28 | ION 14 | 0.75 |
| 88 | 34 | ION 15 | 2.0 |
| 89 | 20 | ION 16 | 0.4 |
| 90 | 24 | ION 17 | 0.8 |
| 91 | 32 | ION 18 | 1.0 |

### Examples 92-93

Abrasion resistance was assessed according to the following procedure. Wear test coupons were cut from injection molded plaques of ionomer ION 19. The wear test coupons were 50 mm by 50 mm by 6.35 mm thick. The wear test coupons were dried in a vacuum oven (20 inches Hg) at room temperature for at least 15 hours and then weighed. The wear test coupons were then mounted in a test chamber and a 10 wt % aqueous sand (AFS50-70 test sand) slurry at room temperature (20 to 25° C.) was impinged on the wear test coupon through a slurry jet nozzle positioned 100 mm from its surface with a diameter of 4 mm at a slurry jet rate of 15-16 meters/second with a slurry jet angle of 900 relative to the surface plane for 2 hours. The wear test coupons were then removed and dried in a vacuum oven (20 inches Hg) at room temperature for at least 15 hours and then reweighed (Example 92). In Example 93 wear test coupons were tested as described for Example 92 except the sand slurry was impinged on the wear test coupon at a slurry jet angle of 25° relative to the surface plane. The results are reported in Table 10.

TABLE 10

| | | Initial Weight | Final Weight | Weight Loss | |
|---|---|---|---|---|---|
| Example | Material | (grams) | (g) | (g) | (%) |
| 92 | ION 19 | 9.5565 | 9.5326 | 0.0239 | 0.25 |
| 93 | ION 19 | 9.5332 | 9.5160 | 0.0172 | 0.18 |

1. A pipe- or tube-shaped article having an innermost layer wherein
the innermost layer has a thickness of about 6.3 to about 102 mm and comprises an ionomer composition;
the ionomer is made from an acid polymer comprising an a-olefin having 2 to 10 carbons and about 5 to about 25 weight % based on the total weight of the acid polymer of an α,β-ethylenically unsaturated carboxylic acid having 3 to 8 carbons; and
about 5 to about 90% of the carboxylic acids are neutralized with a metal ion.

2. The article of claim 1 wherein the α-olefin consists essentially of ethylene and the carboxylic acid is acrylic acid, methacrylic acid, or mixtures thereof and about 10 to about 50% of the carboxylic acids are neutralized with sodium ion, lithium ion, magnesium ion, zinc ion, or mixtures of two or more thereof.

3. The article of claim 2 wherein the ionomer composition further comprises from about 0.1 to about 80 weight %, based on the total weight of the ionomer composition, of abrasion-resistant filler.

4. The article of claim 2 further comprising an outer layer having a thickness of about 0.1 to about 102 mm and comprising rubber, elastomer, thermoplastic elastomer, acid terpolymer, ionomer terpolymer, or mixtures of two or more thereof.

5. The article of claim 4 wherein the outer layer comprises a high strength fiber and optionally a thermoset resin wherein the high strength fiber is produced from fiberglass, continuous glass fiber, polyaramide fiber, aramid fiber, graphite, carbon fiber, silica, quartz, ceramic, silicon carbide, boron, alumina, alumina-silica, polyethylene, ultrahigh molecular weight polyethylene, polyimide, liquid crystal polymers, polypropylene, polyester, or polyamide.

6. The article of claim 5 further comprising an intermediate layer comprising rubber, elastomer, thermoplastic elastomer, acid terpolymer, ionomer terpolymer, or mixtures of two or more thereof.

7. The article of claim 6 wherein the high strength fiber is filament, warp yarn, unidirectional sheet, mat, cloth, knitted cloth, paper, non-woven fabric, woven fabric, or mixtures of two or more thereof.

8. The article of claim 2 comprising an outermost layer.

9. The article of claim 8 wherein the innermost layer is in contact with the outermost layer that comprises carbon steel, steel, stainless steel, cast iron, galvanized steel, aluminum, or copper, or alloys of two or more thereof.

10. The article of claim 9 wherein the outermost layer comprises carbon steel.

11. The article of claim 3 comprising an outermost layer.

12. The article of claim 11 wherein the innermost layer is in contact with the outermost layer that comprises carbon steel, steel, stainless steel, cast iron, galvanized steel, aluminum, or copper, or alloys of two or more thereof.

13. The article of claim 12 wherein the outermost layer comprises carbon steel.

14. The article of claim 7 comprising a metal layer comprising carbon steel, steel, stainless steel, cast iron, galvanized steel, aluminum, or copper, or alloys of two or more thereof.

15. The article of claim 14 wherein the innermost layer is in contact with the metal layer.

16. The article of claim 15 wherein the metal layer comprises carbon steel.

17. A method comprising laying up a pre-formed film or sheet into a preformed metal or plastic pipe to produce ionomer-lined metal or plastic pipe wherein the film or sheet is monolayer or multilayer film or sheet and is produced from an ionomer composition; and the pre-formed film or sheet is as recited in claim 3.

18. The method of claim 17 further comprising heating the metal or plastic pipe above the softening point of the ionomer composition and allowing the metal pipe to cool to produce the ionomer-lined metal or plastic pipe.

19. A method comprising pulling or inserting an article into the interior surface of a metal pipe to produce a pipe- or tube-shaped article comprising an ionomer; wherein the pipe is the article characterized in claim 1.

20. The method of claim 19 further comprising producing an abrasive material; flowing the abrasive material into one end of the pipe- or tube-shaped article; receiving the abrasive material out of the other end of pipe- or tube-shaped article for transporting the abrasive material.
